(19) United States
(12) Patent Application Publication
(10) Pub. No.: US 2007/0171506 A1
(43) Pub. Date: Jul. 26, 2007

(54) THERMOCHROMIC INK TO HIDE/REVEAL GRAPHICS

(75) Inventors: John J. Jordan, Cincinnati, OH (US); Tami M. Wallace, Union, KY (US)

Correspondence Address: FROST BROWN TODD, LLC, 2200 PNC CENTER, 201 E. FIFTH STREET, CINCINNATI, OH, 45202, US

(73) Assignee: Chiquita Brands, Inc., Cincinnati, OH (US)

(21) Appl. No.: 11/627,394

(22) Filed: Jan. 26, 2007

Related U.S. Application Data
(60) Provisional application No. 60/762,410, filed on Jan. 26, 2006.

(51) Int. Cl. G02F 1/01

(52) U.S. Cl. 359/288

(57) ABSTRACT

An article on which a message or a design appears when a certain temperature is reached is described. The article comprises a substrate, a first layer printed on said substrate using regular ink, and a second layer printed on said substrate or first layer using thermochromic ink. The substrate must be selected such that it is of a color which provides a visually discernable contrast between the substrate and the color of the first layer. Further, the hue and chroma of the first layer must be adjusted to the hue and chroma of the second layer in its cold state to ensure that the first layer is hidden. The method of making this article is also disclosed.

This application is related to and claims priority from U.S. Provisional Patent Application No. 60/762,410, filed Jan. 26, 2006, incorporated herein by reference.

### TECHNICAL FIELD

The present invention relates to articles utilizing thermochromic ink which permit an underlying message, either a design or text, to be concealed in one temperature range but become visible at all other temperatures. This invention allows the concealing of the underlying message to be performed using printing methods that lay down thin layers of ink, such as flexography or lithography. This technology could be used, for example, on packages in which food products are heated (for instance, in a microwave oven), to provide the user with a visual marker when the heating/cooking has been completed and the food is ready to be consumed.

### BACKGROUND OF THE INVENTION

Convenience food products are becoming more and more popular. One particular subgroup of this type of product includes those packaged in containers which can be placed directly into a microwave oven (often a single-serving container), and which can then be microwaved for a period of time, providing the user with a ready-to-eat food product. An example of such a product is the single-serving packages of soup which are currently available. Such packages are placed in the microwave for a short period of time and the consumer has hot soup for a quick lunch or snack. Frequently, these products are aimed at children, and so it would be very convenient if the packaging included a marker which would allow the consumer (in this case, a child) to readily see if the food is ready to be eaten. That is a major focus of the present invention.

Thermochromic inks are known in the printing industry. These are inks which appear as one color when they are at or below a design (preset, specific) temperature, and which change color when they are warmed above this temperature (or, in some executions, cooled below this temperature). One approach, therefore, which could be used to provide the temperature marker, discussed above, would be to cover over a graphic message with a thermochromic ink. If the thermochromic ink changes to a clear or very light color upon heating, the underlying graphics will become visually perceptible to the consumer. This approach presents some significant problems. Specifically, thermochromic inks are normally very thin and would not cover graphics underneath them very well, especially if the graphics are in a darker color. As a result, if this approach is to be used, the thermochromic ink would have to be printed using a method, such as screen printing, which lays down ink in a very thick layer so as to conceal the underlying graphics. Normally, screen printing is expensive since it is very slow and requires a large amount of ink, relative to other printing methods. Screen printing also does not print with a very high resolution. At the same time, thermochromic ink manufacturers discourage the use of printing methods such as lithography with thermochromic inks, since lithography tends to apply inks in very thin layers, as compared to other printing methods. Lithography is generally a favored printing method with regular inks because of its low cost, high speed and excellent print quality, but since the inks are laid down in a thin layer, lithography would not generally be thought to be appropriate for use with thermochromic inks in the type of structure described above, since they would not conceal graphics well in the bottom printed layer.

The present invention permits the formulation of the type of graphic marker discussed above while allowing the printer to use a high-speed print method, such as flexography or lithography, and lay down a thin layer of ink but still sufficiently hide the graphics in the bottom layer.

### SUMMARY OF THE INVENTION

In its most general sense, the present invention relates to a container adapted for holding a food product (such as one adapted for use in a microwave oven) which comprises on its outer surface a text message which indicates that the food product in the container is at the appropriate temperature to consume, and wherein that text message becomes visible when the appropriate temperature for food consumption has been reached.

More specifically, the present invention relates to an article comprising a substrate, a first layer printed on said substrate using regular ink, and a second layer printed on said substrate and/or first layer using thermochromic ink, wherein:
(a) the substrate is of a color which provides a visually discernable contrast between the substrate and the color of the first layer;
(b) the hue of the first layer is substantially the same as the hue of the second layer in its cold state; and
(c) the chroma of the first layer is selected or adjusted such that the first layer is camouflaged by the second layer in its cold state.

The present invention also encompasses a method for manufacturing the type of article described above, comprising the steps of: printing said first layer on said substrate using any printing process; and printing said second layer on said first layer using a lithographic or flexographic process.

### DETAILED DESCRIPTION OF THE INVENTION

The present invention relates to an article which includes a graphic and/or text message which becomes visible when the article reaches a certain defined temperature. The article comprises three basic components: a substrate, a first layer printed on that substrate using regular ink, and a second layer printed on the first layer using thermochromic ink. By the appropriate selection, application and combination of these components, that objective can be achieved.

The substrate can be any material which is appropriate for its underlying purpose, and which can be printed upon. Thus, for example, the substrate may be a plastic or a polymer material, or reinforced waxed cardboard, if it is to be used in a package to contain a food product. The present invention is generally going to be used on an object which has a particular purpose. For example, the present invention may be used on a container which holds microwavable food. The substrate is chosen so that it is appropriate for use in that underlying purpose. The substrate should be of a color so as to provide a visually discernable contrast between the color of the substrate and the color of the graphics on the first layer. Obviously, such a contrast is necessary in order for the user ultimately to see the graphics which comprise the first layer. The greater the contrast, the more discernable will be the graphic message when it becomes visible. Multiple colors may be used in the first layer. In one embodiment, the substrate is of a light color, for example, white, off-white, pale pink, pale yellow or pale blue.

On that substrate is placed a first layer. The first layer is printed using regular printer's ink and is applied to the substrate using any appropriate printing process. The first layer should contain a desired graphic image, which generally will comprise design elements and/or text elements. It is this graphic image which the viewer will see when the desired temperature conditions are met. Thus, for example, if the present invention is to be used on a microwavable food package for the purpose of indicating to the user that the food is at the recommended temperature to eat, the text on the first layer could read “READY NOW!” or “READY TO EAT!” or “BON APPETIT!”.

The second layer is placed on top of the first layer and its general purpose is to temporarily mask the graphics of the first layer. The second layer is made from a thermochromic ink and may be applied using any known printing process, although processes such as lithography or flexography are preferred since they tend to be of the highest quality, greatest speed and lowest cost. It is, in fact, an important aspect of the present invention that it permits the masking of the first layer using a thermochromic ink and a flexographic or lithographic process, which lays down only a thin layer of the ink. Thermochromic inks are well known in the art. The key characteristic of thermochromic inks is that they are of one color in their cold state (for example, at room temperature), and they change to a different color in their warm state. It is preferred that there be a discernable contrast between the hot color and the cold color of the thermochromic ink used in the second layer. It is particularly preferred that there be a significant contrast between the cold color and hot color of the thermochromic ink used in the second layer. Clearly, the greater the contrast between the cold and the hot colors, the more striking will be the visibility of the graphics on the first layer when it becomes visible.

It is to be understood that the first and second layers may be reversed and still be within the scope the present invention. Thus, the thermochromic layer may be applied first to the substrate and the regular ink layer may be applied second and over the thermochromic ink layer.

Regardless of the method by which the first layer and the second layer are printed onto the substrate, they should be printed in a way which provides a two-dimensional surface texture to both layers. The surface texture acts to assist in hiding the bottom (first) layer.

In order to get the desired effect from the present invention, it is important that the hue and the chroma of the inks used in the first and second layers be very carefully selected relative to each other. Specifically, it is important that the hue of the first layer be substantially the same as the hue of the second layer in its cold state. Hue is a well-known characteristic of colored inks (i.e., it defines the “color” of the ink) and it is measured by well-known devices, such as a calorimeter. By “substantially the same,” as used herein, is meant that the hue of the first layer and the hue of the second layer in its cold state appear visually indiscernible to an untrained observer.

In addition to the hue matching, it is important that the chroma of the first layer be substantially the same as or less than the chroma of the second layer in its cold state. Chroma is also a term well known in the graphic arts and it is a measure of the percentage of area that an ink covers on a substrate. The chroma of the first layer should be reduced such that an untrained observer cannot see the text or graphics when the two layers (the first layer, and the second layer in its cold state) are combined. By properly adjusting the hue and the chroma of the inks in the first and second layers, it is possible to put down the second layer, even a thin second layer, using a lithographic or a flexographic process, which conceals the graphics of the first layer. The ability to adjust the chroma and the hue of the inks is something well within the skill of one of ordinary skill in the graphic arts.

In the article of the present invention, as it is constructed, the graphic design of the first layer on the substrate would ordinarily be visible to the eye of an observer because of the contrast between the color of the first layer ink and the color of the substrate. However, because of the chroma and hue between the inks of the first and second layers, when the second layer is applied, it both blends with and covers the design of the first layer and masks it to the eye of an observer. When the article is heated up beyond its critical point (i.e., the temperature at which the thermochromic ink changes colors), the color of the thermochromic ink in the second layer changes to its hot color, which no longer matches the color of the first layer. [It is to be noted that the thermochromic ink may be selected such that the underlying graphics of the first layer become visible when the article is cooled down from its typical temperature, and that is included within the scope of the present invention.] As seen by an observer, this allows the graphics on the first layer to become visible, permitting the design or text message to be viewed by that observer. If a specific temperature cut-off is critical for operability (for example, if you want your product to be heated to 35° F. or 90° F.), then it is important to select a thermochromic ink which has a critical temperature for switching between the hot and the cold colors which is close to the critical temperature you are trying to indicate. Thus, if you are trying to have an indicator which marks a temperature of 35° F., then the thermochromic ink should have a hot/cold color transition temperature of about 35° F.

Additional layers, made from regular or thermochromic ink, may be added to the article to provide additional effects.

An example of the present invention follows. A frozen ice cream drink (e.g., a milkshake or a malt) is formulated and placed in a waxed cardboard cup with a top. The graphics on the outside of the cup include the brand name of the product, the flavor of the drink, the name of the company making and selling the product, nutritional information, instructions for preparation (heating), and a pink circle on the front of the cup. The pink circle is an embodiment of the present invention. Specifically, the pink circle includes a first layer made up of the words “READY NOW!” printed onto the circle using regular ink (for example, PMS 217 magenta with a 35% chroma). On top of the first layer is a second layer of ink which is a thermochromic ink and is printed on using a lithographic process (for example, PMS 217 magenta thermochromic ink). Because of the coordination and adjustment of the hue and chroma of the ink color of the first layer and the cold ink color of the second layer, the circle appears to be a blank pink circle and is part of the decoration of the cup. The transition temperature between hot color and cold color of the thermochromic ink is about 35° F. The instructions say to place the frozen product in a microwave oven under medium power and heat it for 30-60 seconds. The goal in doing that is to heat the product from its frozen state up to about 35° F., at which point it has the appropriate consistency for a milkshake-like drink and can be consumed. The cup is placed in the microwave oven according to the instructions and when it reaches 35° F. the color on the second layer of the pink circle changes, exposing the words “READY NOW!” to the user. At that point, the user knows that the product has been heated enough and that the milkshake drink can be consumed.

It is to be understood that the present invention is not limited to use in food packages or heating in a conventional or microwave oven. It can be used in any package in which a temperature change is to be indicated to the user. For example, a medication or chemical can be stored, in frozen form, in a package of the present invention. The package would indicate when its contents have reached room temperature and therefore are ready to use.

What is claimed is:

1. An article comprising a substrate, a first layer printed on said substrate using regular ink, and a second layer printed on said substrate or first layer using thermochromic ink, wherein:
(a) the substrate is of a color which provides a visually discernable contrast between the substrate and the color of the first layer;
(b) the hue of the second layer in its cold state is substantially the same as the hue of the first layer; and
(c) the chroma of the first layer is selected or adjusted such that the first layer is camouflaged by the second layer in its cold state.

2. The article according to claim 1 wherein both the first and second layers are printed so as to have two-dimensional surface texture.

3. The article according to claim 2 wherein the first layer comprises text which conveys a message.

4. The article according to claim 1 wherein the first layer comprises a design.

5. The article according to claim 2 where there is a visually discernable contrast between the cold and hot colors of the second layer.

6. The article according to claim 5 wherein there is a significant contrast between the cold and hot colors of the second layer.

7. The article according to claim 2 wherein the second layer is printed using a lithographic or flexographic process.

8. The article according to claim 2 wherein the article is a container which holds a food product.

9. The article according to claim 8 wherein the first layer includes a message indicating that the food product has reached a desired temperature.

10. An article according to claim 9 wherein the second layer changes from its cold color to its hot color at said desired temperature.

11. A method for manufacturing the article of claim 1 comprising the steps of: printing said first layer on said substrate using any printing process; and printing said second layer on said first layer using a lithographic or flexographic process.

12. The method according to claim 11 wherein the first layer is printed using a lithographic or a flexographic process.

13. The method according to claim 11 wherein both first and second layers are printed such that they have two-dimensional surface texture.

14. A container holding a food product which comprises on its outer surface a text message which indicates that the food product is at the appropriate temperature to consume, and which becomes visible only when said temperature has been reached.

15. An article comprising a substrate, a first layer printed on said substrate using thermochromic ink, and a second layer printed on said substrate or first layer using regular ink, wherein:
(a) the substrate is of a color which provides a visually discernible contrast between the substrate and the color of the second layer;
(b) the hue of the first layer in its cold state is substantially the same as the hue of the second layer; and
(c) the chroma of the second layer is adjusted such that the second layer is camouflaged by the first layer in its cold state.

16. The article according to claim 15 wherein the second layer comprises text and/or a design.

17. The article according to claim 16 wherein both the first and second layers are printed such that they have two-dimensional surface texture.

18. A method for indicating temperature change of a material comprising placing said material in a package which incorporates the article of claim 1, at an initial cold state temperature, and subjecting said package to a process which results in a temperature change for the material to a warm state temperature.

19. The method of claim 18 wherein said process is selected from warming at room temperature, warming in a water bath, warming in a conventional oven, and warming in a microwave oven.
